(19) United States
(12) Patent Application Publication
(10) Pub. No.: US 2024/0073105 A1
(43) Pub. Date: Feb. 29, 2024

(54) POSITION CONTROL APPARATUS, METHOD, AND PROGRAM

(71) Applicant: NIPPON TELEGRAPH AND TELEPHONE CORPORATION, Tokyo (JP)

(72) Inventors: Kazuaki AKASHI, Musashino-shi, Tokyo (JP); Haruhisa NOZUE, Musashino-shi, Tokyo (JP)

(73) Assignee: NIPPON TELEGRAPH AND TELEPHONE CORPORATION, Tokyo (JP)

(21) Appl. No.: 18/271,474

(22) PCT Filed: Jan. 13, 2021
(86) PCT No.: PCT/JP2021/000847

§ 371 Date: Jul. 10, 2023

(51) Int. Cl. H04L 41/22; H04L 41/122

(52) U.S. Cl. CPC H04L 41/22; H04L 41/122

(57) ABSTRACT

A position control device includes a first input unit to receive input of information related to a virtual node that generates attraction or repulsion according to the types of a plurality of types of nodes, and to receive, for each of a plurality of areas on a screen, input of information related to the plurality of types of nodes and links displayable in the areas. Further, there is a second input unit to receive, for at least one of the plurality of areas, input of information related to setting of any display positions of the nodes indicated by the information that is input, and a parameter calculation unit to calculate a parameter for calculating attraction or repulsion applied by the virtual node to the nodes at the display positions. Additionally, there is a determination unit configured to calculate attraction or repulsion applied by the virtual node.

### TECHNICAL FIELD

An embodiment of the present invention relates to a position control device, a method, and a program.

### BACKGROUND ART

In a system for operating and monitoring a communication network, when a configuration diagram of a large-scale network is displayed on a screen of a display device, it is desirable to divide an area of the network configuration on the screen into a plurality of areas and then automatically arrange nodes (devices) of the respective areas on the screen.

Techniques for automatically drawing a network configuration diagram on a screen include, for example, a technique for automatically arranging nodes on a screen by a Fruchterman-Reingold algorithm using the dynamic model disclosed in Non Patent Literature 1. This model is a model for obtaining optimum positions of nodes by assuming that repulsion acts between nodes and attraction acts between nodes that have a connection relation.

The technique calculates positions for drawing a network configuration diagram so as to prevent a node or the like from being displayed over other nodes or the like on the screen searching for a stable state by simulation with assumption that attraction and repulsion act to balance nodes at an ideal distance, and is a type of de facto standard of an automatic arrangement algorithm of nodes.

### CITATION LIST

### Non Patent Literature

Non Patent Literature 1: T. M. J. Fruchterman, and E. M. Reingold, “Graph drawing by force directed placement,” Software practice and experience, John Wiley & Sons, Ltd., U.S.A, 1991, pp. 1129-1164. http://citeseerx.ist.psu.eduiviewdoc/download?doi=10.1.1.13.8444&rep=rep1&type=pdf

### SUMMARY OF INVENTION

### Technical Problem

However, for the technique for automatically arranging nodes using the existing dynamic model, it is difficult to take account of an arrangement policy of an operation and monitoring organization or the like to automatically determine the position of each node. Specifically, the policy is that at which position, each of the nodes of different types should be displayed.

For example, in a case where a network including a router, a layer2 switch, and a server in a certain organization is to be drawn, there ma'y′ be a case where a user or an administrator (sometimes referred to as a user or the like) of the system desires a drawing that represents a tree structure including, for example, the router arranged in the upper layer of the screen, the layer2 switch arranged in the middle layer of the screen, and the server arranged in the lower layer of the screen.

Meanwhile, in another organization, for the same network, there may be a case where a user or the like desires the router arranged in the center of the screen, and from that position, the layer2 switch and the server radially arranged.

Furthermore, it is also conceivable that a type of node in a network, which is the router, the layer 2 switch or the server in the above example, varies depending on a network to be managed.

The existing dynamic model reflects only a distance between nodes, and then, does not reflect the arrangement policy as described above. For this reason, in the system that operates and monitors a network, it has been necessary to develop or set functions for each policy related to arrangement.

The present invention has been made in view of the above circumstances, and an object thereof is to provide a position control device, a method, and a program capable of appropriately arranging nodes in a plurality of areas.

### Solution to Problem

A position control device according to one aspect of the present invention includes a first input unit configured to receive input of information related to a virtual node that generates attraction or repulsion on a plurality of types of nodes displayable in an area of a screen according to the types of the nodes, and to receive, for each of a plurality of areas on a screen, input of information related to a plurality of types of nodes and a link connecting the plurality of types of nodes displayable in the areas, a second input unit configured to receive, for at least one of the plurality of areas, input of information related to setting of any display positions of the nodes indicated by the information input via the first input unit, a parameter calculation unit configured to calculate, for each of the types of the nodes, a parameter for calculating attraction or repulsion applied by the virtual node indicated by the information input via the first input unit to the nodes at the display positions of the nodes indicated by the information input via the second input unit, based on the information input via the first and second input units, and a determination unit configured to calculate attraction or repulsion applied by the virtual node indicated by the information input via the first input unit to the nodes at the display positions indicated by the information input via the second input unit based on the parameter calculated by the parameter calculation unit, and to determine display positions of the nodes indicated by the information input via the second input unit for each of the areas based on the attraction or the repulsion that is calculated.

A position control method according to one aspect of the present invention that is performed by a position control device including, receiving input of information related to a virtual node that generates attraction or repulsion on a plurality of types of nodes displayable in an area of a screen according to the types of the nodes, and receiving, for each of a plurality of areas of a screen, input of information related to the plurality of types or nodes displayable in the area and a link connecting the plurality of types of nodes, receiving, for at least one of the plurality of areas, input of information related to setting of any display positions of the plurality of types of nodes indicated by the information that is input, calculating, for each of the types of the nodes, a parameter for calculating the attraction or the repulsion applied by the virtual node indicated by the information that is input to the nodes at the display positions of the nodes indicated by the information that is input, based on the information that is input, calculating attraction or repulsion applied by the virtual node indicated by the information that is input to the nodes at the display positions of the nodes indicated by the information that is input, based on the parameter that is calculated, and determining display positions of the nodes indicated by the information that is input for each of the areas, based on the attraction or the repulsion that is calculated.

### ADVANTAGEOUS EFFECTS OF INVENTION

According to the present invention, nodes in a plurality of areas can be appropriately arranged.

### BRIEF DESCRIPTION OF DRAWINGS

FIG. 1 is a block diagram illustrating an application example of a network configuration diagram Generation device according to an embodiment of the present invention.

FIG. 2 is a diagram illustrating, in tabular form, an example of virtual node information stored in a virtual node information storage unit.

FIG. 3 is a diagram illustrating, in tabular form, an example of node information stored in a configuration information storage unit.

FIG. 4 is a diagram illustrating, in tabular form, an example of link information stored in the configuration information storage unit.

FIG. 5 is a diagram illustrating, in tabular form, an example of sample arrangement information stored in a sample arrangement information storage unit.

FIG. 6 is a diagram illustrating, in tabular form, an example of arrangement information stored in as arrangement information storage unit.

FIG. 7 is a flowchart illustrating an example of a procedure of processing operations by the network configuration diagram generation device according to an embodiment of the present invention.

FIG. 8 is a flowchart illustrating an example of a procedure of processing operations by a configuration information input unit.

FIG. 9 is a flowchart illustrating an example of a procedure of processing operations by a sample arrangement information input unit.

FIG. 10 is a flowchart illustrating an example of a procedure of processing operations by a parameter calculation unit.

FIG. 11 is a diagram illustrating a premise Los Parameter calculation.

FIG. 12 is a flowchart illustrating an example of a procedure of processing operations by an arrangement information output unit.

FIG. 13 is a diagram illustrating, in tabular form, an example of the virtual node information in which positions of virtual nodes are registered.

FIG. 14 is a diagram illustrating an example of the positions of the virtual nodes registered in the virtual node information.

FIG. 15 is a diagram illustrating, in tabular form, an example of the node information that is updated.

FIG. 16 is a diagram illustrating, in tabular form, an example of the link information that is updated.

FIG. 17 is a diagram illustrating, in tabular form, an example of the arrangement information that is updated.

FIG. 18 is a diagram illustrating, in tabular form, an example of the virtual node information to which types of nodes are added.

FIG. 19 is a diagram illustrating an example of input of the sample arrangement information.

FIG. 20 is a diagram illustrating an example of parameter calculation of the virtual node information.

FIG. 21 is a diagram illustrating, in tabular form, an example of the virtual node information reflecting the parameters that are calculated.

FIG. 22 is a diagram illustrating an example of determining the arrangement information.

FIG. 23 is a diagram illustrating, in tabular form, a calculation result of the arrangement information.

FIG. 24 is a diagram illustrating an example of a displaying result of the arrangement information on a screen.

FIG. 25 is a diagram illustrating an example of a displaying result of the arrangement information on a screen.

FIG. 26 is a diagram illustrating another example of the sample arrangement information and a result of the parameter calculation.

FIG. 27 is a diagram illustrating an example of a displaying result of the arrangement information on a screen.

FIG. 28 is a block diagram illustrating an example of a hardware configuration of the network configuration diagram generation device according to an embodiment of the present invention.

### DESCRIPTION OF EMBODIMENTS

Hereinafter, an embodiment according to the present invention will be described with reference to the drawings.

In an embodiment of the present invention, using a conventional dynamic model as a base, any number of virtual nodes that apply a force different for each type of a plurality of types of nodes to the corresponding node are arranged. Then, distances between a virtual node and nodes of each type are acquired based on positions of the nodes in an area that are arranged manually, that is, by any input operation by a user or the like of the system to calculate as average value and variations of the acquired distances for the nodes of each type.

Then, in an embodiment of the present invention, each virtual node applies forces for making the distances between itself and the nodes of each type closer to an average value of the acquired distances (ideal distance as described later) to the nodes, so that the forces are stronger as variations in the acquired distances are smaller. Consequently, the positions of the nodes in the area that are manually arranged are automatically reflected to the positions of the same types of nodes in another area.

The embodiment of the present invention eliminates the need for developing and setting of automatic node arrangement functions for each organization that operates and monitors networks, and may achieve automatic generation of a network configuration diagram reflecting a node arrangement policy of the above organization.

Consequently, it is possible to expect an effect of reducing management operation and cost required for development of a system that operates and monitors networks.

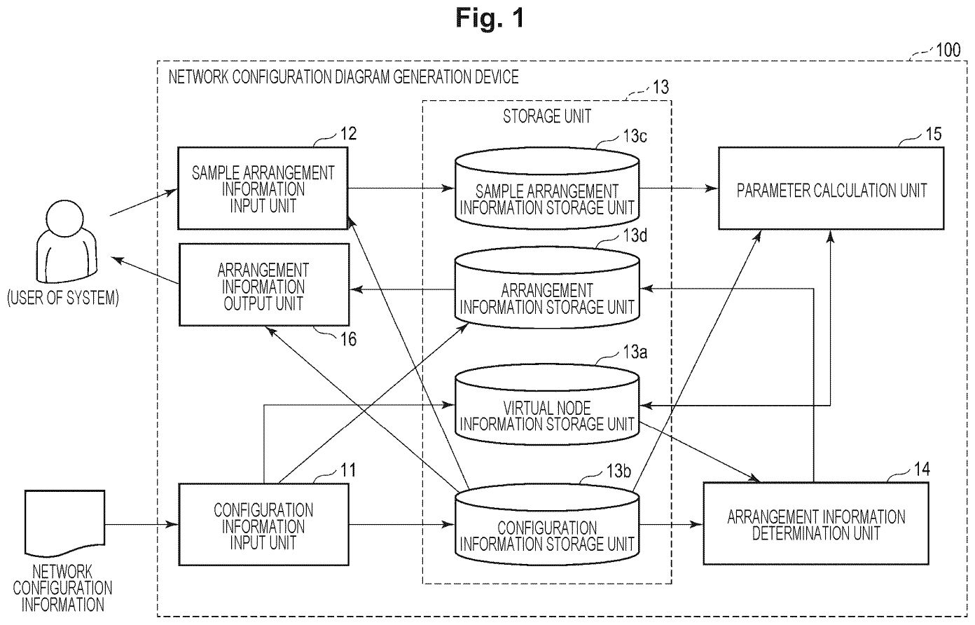

FIG. 1 is a block diagram illustrating an application example of a network configuration diagram generation device according to the embodiment of the present invention.

As illustrated in FIG. 1, a network configuration diagram generation device (also referred to as a network configuration diagram automatic generation device or a position control device) 100 according to the embodiment of the present invention includes a configuration information input unit 11, a sample arrangement information input unit 12, a storage unit 13, an arrangement information determination unit 14, a parameter calculation unit 15, and an arrangement information output unit 16.

The storage unit 13 includes a virtual node information storage unit 13a, a configuration information storage unit 13b, a sample arrangement information storage unit 13c, and an arrangement information storage unit 13d.

The configuration information input unit 11 is configured to receive input of network configuration information from the outside. The sample arrangement information input unit 12 and the arrangement information output unit 16 are used by a user or the like of the system of the network configuration diagram generation device 100.

The virtual nod information storage unit 13a stores virtual node information including position information of any number of virtual nodes. The virtual node information may be included in the above-described network configuration information that is input.

The configuration information input unit 11 is configured to receive input of information, for a plurality of areas, of each of normal nodes (devices) and links (cables that each communicably connects a plurality of nodes (devices)) as the network configuration information. The normal node described above may be simply referred to as a node.

The sample arrangement information input unit 12 is configured to receive input of any arrangement information of nodes in at least one area indicated by the network configuration information through an input operation by a user or the like.

The parameter calculation unit 15 calculates parameters used for calculation of attraction and repulsion to be applied to nodes. The parameters include (1) an ideal distance between a virtual node and the nodes of each type, and (2) a coefficient of the attraction and the repulsion (hereinafter, also simply referred to as a coefficient) applied to nodes. Descriptions thereof will be given later.

The arrangement information determination unit 14 determines positions of nodes in all areas by automatically arranging the nodes using the dynamic model using the parameters calculated by the parameter calculation unit 15.

The arrangement information output unit 16 outputs, for each area, nodes and links, which communicably connect the plurality of nodes, by displaying them on the screen, for example.

Next, examples of columns of information stored in each information storage unit will be described.

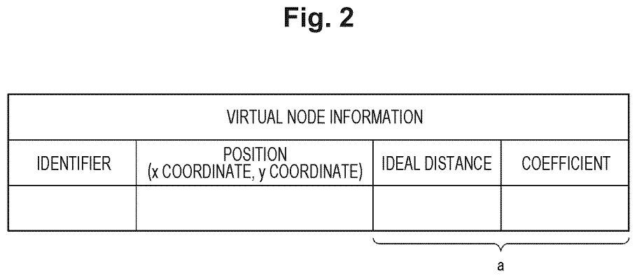

FIG. 2 is a diagram illustrating, in tabular form, an example of virtual node information stored in a virtual node information storage unit.

As illustrated in FIG. 2, the virtual node information includes (1) identifiers of virtual nodes arranged on the screen, (2) positions (x coordinate, y coordinate) of the virtual nodes, and (3) parameters used for calculation of attraction and repulsion applied by the virtual nodes to nodes of each type. The parameters indicated by the reference sign a in FIG. 2, include (1) an ideal distance between the virtual node and nodes of each type, and (2) a coefficient of the attraction and the repulsion applied to the node, and are set for each type of the nodes of the respective types.

The configuration information storage unit 13b stores the node information for each type of nodes and the link information described below. The node information and the link information may be referred to as configuration information, and may be included in the above-described network configuration information that is input.

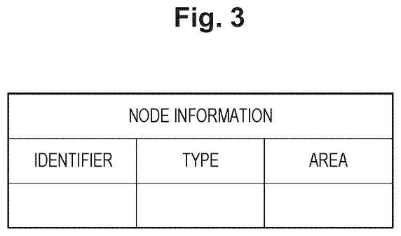

FIG. 3 is a diagram illustrating, in tabular form, an example of node information stored in a configuration information storage unit.

As illustrated in FIG. 3, the node information is set for each node, and includes (1) an identifier of the node, (2) a type of the node, and (3) an identifier of an area in which the node is provided.

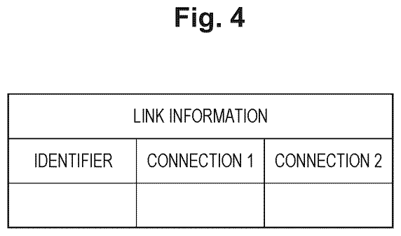

FIG. 4 is a diagram illustrating, in tabular form, an example of link information stored in the configuration information storage unit.

As illustrated in FIG. 4, the link information includes (1) an identifier of a link and (2) identifiers of connected nodes, which are nodes provided at both ends of the link. “Connection 1” in FIG. 4 is a column of an identifier of the node provided at one end of the link, and “connection 2” is a column of an identifier of the node Provided. at the other end of the link.

The sample arrangement information storage unit 13c stores sample arrangement information described below.

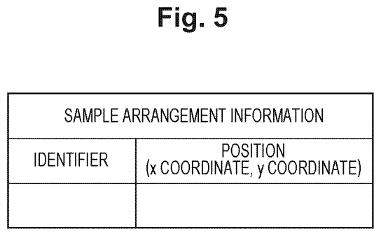

FIG. 5 is a diagram illustrating, in tabular form, an example of the sample arrangement information stored in a sample arrangement information storage unit.

As illustrated in FIG. 5, the sample arrangement information includes (1) an identifier of a node in an area manually set (selected) among the areas by a user or the like of the system, and (2) a position (x coordinate, y coordinate) of the node on the screen.

The arrangement information storage unit 13d stores arrangement information described below.

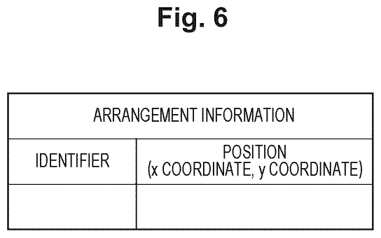

FIG. 6 is a diagram illustrating, in tabular form, an example of the arrangement information stored in an arrangement information storage unit.

As illustrated in FIG. 6, the arrangement information. includes (1) identifiers of all of the nodes indicated by the node information of the configuration information stored in the configuration information storage unit 13b, and (2) positions (x coordinate, y coordinate) of the nodes on the screen.

Next, processing operations by the network configuration diagram generation device 100 will be described.

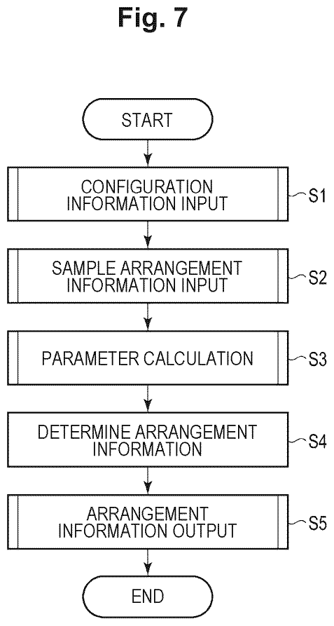

FIG. 7 is a flowchart illustrating an example of a procedure of processing operations by the network configuration diagram generation device according to an embodiment of the present invention.

The configuration information input unit 11 of the network configuration diagram generation device 100 performs configuration information input processing described below (S1). In S1, the configuration information input unit 11 updates the node information stored in the configuration information storage unit 13b and the virtual node information stored in the virtual node information storage unit 13a based on the network configuration information input from the outside.

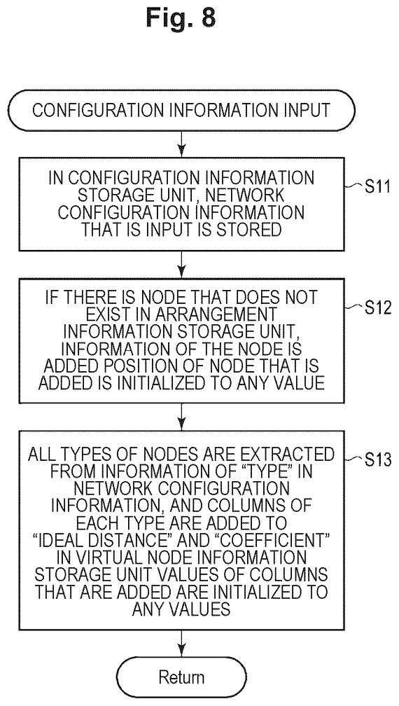

Details of S1 will be described below. FIG. 8 is a flowchart illustrating an example of a procedure of processing operations by a configuration information input unit.

First, the configuration information input unit 11 stores, in the configuration information storage unit 13b, the network configuration information that is input (S11).

If a node that exists in the network configuration information does not exist in the arrangement information stored in the arrangement information storage unit 13d, the configuration information input unit 11 adds the information of the node to the arrangement information stored in the arrangement information storage unit 13d. The values of the x coordinate and the v coordinate of the position of the node added to the arrangement information are initialized to any values (S12).

The configuration information input unit 11 extracts all types of nodes from the information of “type” in the network configuration information, that is, the information of type in the node information stored in the configuration information storage unit 13b, and adds columns corresponding to the above-described types that have been extracted to “ideal distance” and “coefficient” in the virtual node information stored in the virtual node information storage unit 13a (S13). The values of the columns that have been added are initialized to any values. Then, S1 is completed.

After S1, the sample arrangement information input unit 12 of the network configuration diagram generation device 100 performs sample arrangement information input processing described below (S2). In S2, the sample arrangement information input unit 12 acquires the sample arrangement information through a screen operation by a user or the like of the system. This acquisition is not limited to be performed through the screen operation, and may be performed by input in a file format, for example.

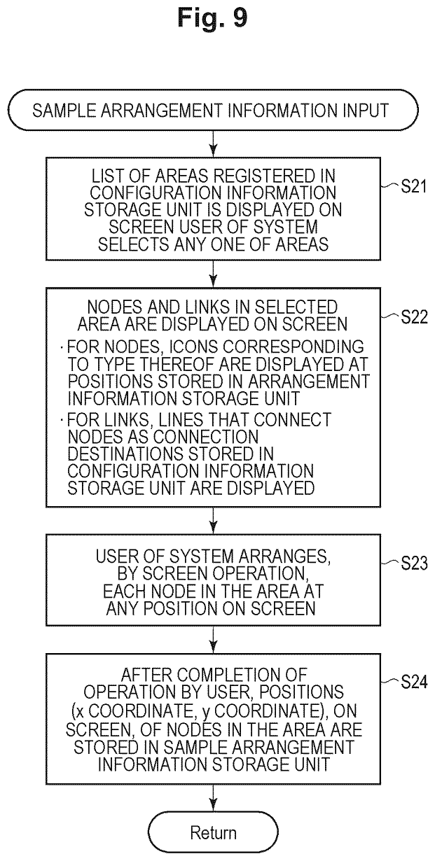

Details of S2 will be described below. FIG. 9 is a flowchart illustrating an example of a procedure of processing operations by a sample arrangement information input unit.

First, the sample arrangement information input unit 12 displays, on the screen, a list of areas registered in the node information stored in the configuration information storage unit 12b. A user or the like of the system can select, through a screen operation, any one of the areas that are displayed (S21).

The sample arrangement information input unit 12 displays, on the screen, information indicating nodes and links in the area that has been selected (S22).

In the display, icons corresponding to nodes of the types are displayed at positions, on the screen, corresponding to “position (x coordinate, y coordinate)” in the arrangement information stored n the arrangement information storage unit 13d.

Furthermore, in the display in S22, lines that connect the nodes as connection destinations are displayed on the screen as links indicated by the link information stored in the configuration information storage unit 12b.

After S22, the sample arrangement information input unit 12 arranges, through a screen operation by a user or the like of the system, each node displayed in S22 at any position on the screen in the area selected in S21 (S23).

According to the arrangement in S22, the sample arrangement information input unit 12 stores a “position (x coordinate, y coordinate)” on the screen arranged in S23 of the node selected in S21 in the sample arrangement information storage unit 13c (S24). Then, S2 is completed.

After S2, the parameter calculation unit 15 of the network configuration diagram generation device 100 performs parameter calculation processing described below (S3).

In S3, the parameter calculation unit 15 calculates the ideal distance and the coefficient, which are parameters for calculating attraction and repulsion applied by each virtual node to nodes of each type, using information stored in the virtual node information storage unit 13a, the sample arrangement information storage unit 13c, and the configuration information storage unit 13b.

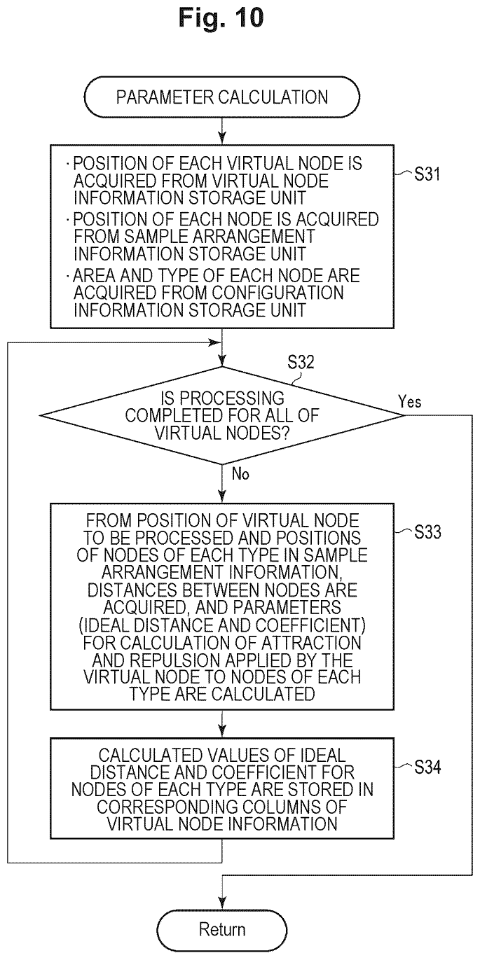

Details of S3 will be described below. FIG. 10 is a flowchart illustrating an example of a procedure of processing operations by a parameter calculation unit.

First, the parameter calculation unit 15 acquires information from the storage units (S31).

Specifically, the parameter calculation unit 15 acquires the positions of the virtual nodes from the virtual node information stored in the virtual node information storage unit 13a. Then, the parameter calculation unit 15 acquires, from the sample arrangement information stored in the sample arrangement information storage unit 13c, the positions of the above-described nodes that have been arranged.

Then, the parameter calculation unit 15 acquires the area and the type of each of the nodes from the node information stored in the configuration information storage unit 13b. Then, S31 is completed.

Then, if the processing in the following S33 and S34 has not been completed (No in S32) for all of the virtual nodes related to the positions acquired in S31, the parameter calculation unit 15 acquires, from the position of the virtual node to be processed and the positions of the nodes of each type in the sample arrangement information, distances between the virtual node and the nodes of each type.

The parameter calculation unit 15 calculates the ideal distance and the coefficient, which are parameters for calculating the attraction and the repulsion applied by the virtual node to the nodes of each type (S33).

The parameter calculation unit 15 stores the values of the ideal distance and the coefficient for the nodes of each type calculated in S33 in the corresponding column in the virtual node information (S34).

When the processing in S33 and S34 is completed for all of the virtual nodes related to the positions acquired in S31 (Yes in S32), the processing of S3 is completed.

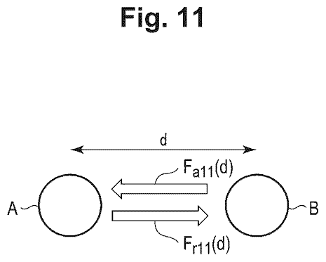

Next, a premise for parameter calculation will be described. FIG. 11 is a diagram illustrating the premise for the parameter calculation.

The attraction and the repulsion that a virtual node applies to nodes of each type are expressed by introducing, into the conventional dynamic model, (1) the ideal distance for each type and (2) the coefficient for each type. Here, the attraction and the repulsion applied by a virtual node to each node are expressed so that each virtual node applies forces for making the distances between itself and the nodes of each type closer to an average value of the acquired distances to the nodes, so that the forces are stronger as variations in the acquired distances are smaller.

Specifically, under the following conditions (a) to (f), attraction F_{aic} and repulsion F_{ric} applied by a virtual node i to a node of type c are expressed as the following equations (1) and (2).

(a) c: type of node to which attraction or repulsion is applied

(b) M: the number of virtual nodes

(c) is virtual node number (i=1, . . . , M)

(d) d: distance between the virtual node and a node of each type

(e) k_{ic}: ideal distance between virtual node i and a node of type c

(f) α_{ic}: coefficient of attraction and repulsion applied by virtual node i to the node of type c (0≤α_{ic}≤1)

$$\begin{matrix}[ Math . 1 ] & \\ {F}_{aic} ( d ) = {α}_{ic} \frac{{d}^{2}}{{k}_{ic}} & EQUATION ( 1 )\end{matrix}$$

$${F}_{ric} ( d ) = - {α}_{ic} \frac{{k}_{ic}^{2}}{d} \qquad EQUATION ( 2 )$$

In an example illustrated in FIG. 11, an example of the attraction Fₐ₁₁(d) and the repulsion F_{R11}(d) applied by the “virtual node 1” indicated by the reference sign A in FIG. 11 to the “node (type 1)” indicated by the reference sign B in FIG. 11 is illustrated.

Next, an ideal distance in the parameter calculation will be described.

The ideal distance k_{ic} between the virtual node i and the node of type c is an average value of distances between the virtual node and each of nodes of type c in the sample arrangement information, and is expressed as the following equation (3) under the following conditions (g) to (i).

(c) m: the number of nodes of type c

(h) j: node number of type c (j=1, . . . , m)

(i) distance between virtual node i and node j in sample arrangement information

$$\begin{matrix}[ Math . 2 ] & \\ {k}_{ic} = \frac{1}{m} \times {\sum }_{j = 1}^{m} {d}_{ij} & EQUATION ( 3 )\end{matrix}$$

Next, a coefficient in the parameter calculation will be described.

In the present embodiment, the coefficient α_{ic} (0≤α_{ic}≤1) of the attraction and the repulsion applied by the virtual node i to the node of type c is a function of variations in the distance between the virtual node i and each of nodes of type c in the sample arrangement information.

For example, when a function having, as a variable, a coefficient of variation v_{ic} of the distance between the virtual node i and the node of type c in the sample arrangement information (a value obtained by dividing a standard deviation of the distance by an average value) is defined as a coefficient of the attraction and the repulsion applied to the above-described node, the coefficient can be calculated by the following equations (4) or (5). In equation (5), x is any threshold value.

$$\begin{matrix}[ Math . 3 ] & \\ {α}_{ic} ( {V}_{icx} ) = \{ \begin{matrix}1 - {V}_{ic} ( {V}_{ic} \leq 1 ) \\ o ( {V}_{ic} > 1 )\end{matrix} & EQUATION ( 4 )\end{matrix}$$

$${α}_{ic} ( {V}_{ic} ) = \{ \begin{matrix}1 ( {V}_{ic} \leq x ) \\ o ( {V}_{ic} > x )\end{matrix} \qquad EQUATION ( 5 )$$

After the above-described S3, the arrangement information determination unit 14 determines the position of each node in the node information stored is the configuration information storage unit 13b based on the node position determination method using the conventional dynamic model (S4).

In the present embodiment, is addition to attraction and repulsion acting between nodes in the conventional dynamic model, attraction and repulsion applied by a virtual node to each node are considered.

Furthermore, for calculation of a position of a virtual node and calculation of attraction and repulsion applied by the virtual node to each node, the ideal distance and the coefficient in the virtual node information stored in the virtual node information storage unit 13a are used.

The information indicating the position of each node determined above is set in the arrangement information stored in the arrangement information storage unit 13d.

For the node of which position information in the sample arrangement information is stored in the sample arrangement information storage unit 13c, the processing of S4 may be skipped, and the position information may be set in the arrangement information to be stored in the arrangement information storage unit 13d.

The processing of S4 is executed by the arrangement information determination unit 14 at any timing. For example, the processing may be executed in a case where an instruction is given by a screen operation by a user or the like of the system, or in a case where information of a new node is input as the configuration information.

After S4, the arrangement information output unit 16 of the network configuration diagram generation device 100 performs arrangement information output processing described below (S5).

In S5, the arrangement information output unit 16 displays the nodes and the links on the screen based on the information stored in the arrangement information storage unit 13d and the configuration information storage unit 13b. The arrangement information output processing may be performed by output in a file format, for example, instead of the display on the screen.

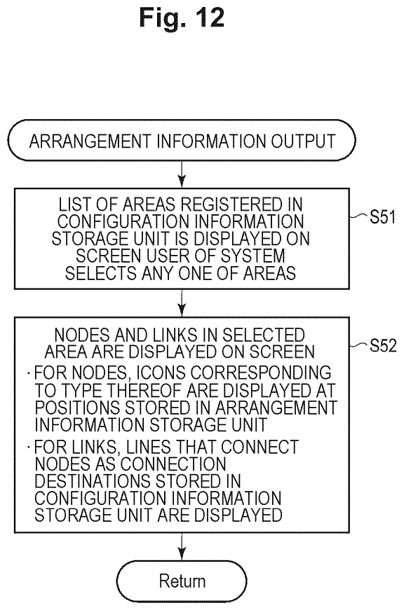

Details of S5 will be described below. FIG. 12 is a flowchart illustrating an example of a procedure of processing operations by an arrangement information output unit.

The arrangement information output unit 16 displays, on the screen, a list of areas registered in the node information stored in the configuration information storage unit 13b. A user or the like of the system can select, through a screen operation, any one of the areas that are displayed (S51).

The arrangement information output unit 16 displays, on the screen, information indicating the nodes and the links in the area that has been selected (S52).

In the display, icons corresponding to the nodes of the types are displayed at positions, on the screen, corresponding to “position (x coordinate, y coordinate)” in the arrangement information stored in the arrangement information storage unit 13d.

Furthermore, in the display in S52, lines that connects the nodes as connect destinations are displayed on the screen as a link indicated by the link information stored in the configuration information storage unit 13b.

Next, a specific example according to the present embodiment will be described.

First, preparation for processing by the network configuration diagram generation device 100 will be described.

The configuration information input unit 11 registers the position information of each virtual node in the virtual node information stored in the virtual node information storage unit 13a according to an input operation by a user or an administrator of the system.

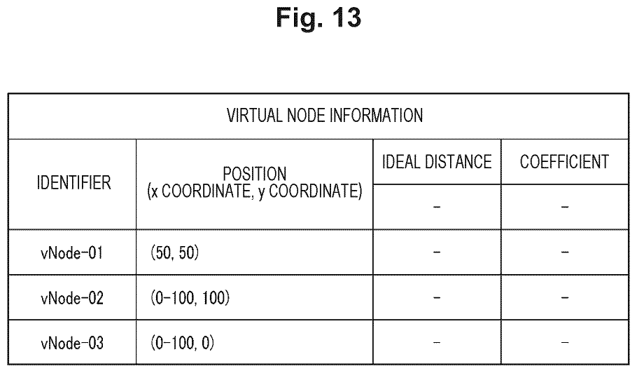

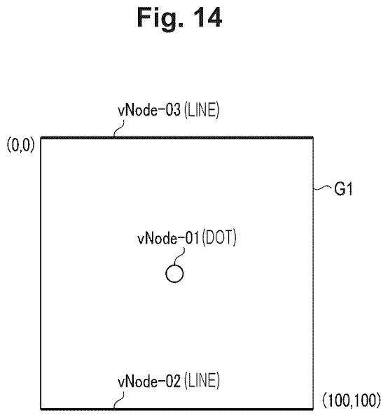

FIG. 13 is a diagram illustrating, in tabular form, an example of the virtual node information in which positions of virtual nodes are registered. FIG. 14 is a diagram illustrating an example of the positions of the virtual nodes registered in the virtual node information.

In the example illustrated in FIG. 13, x coordinates and y coordinates that are position information of three virtual nodes are registered in the virtual node information.

The example illustrated in FIG. 13 firstly indicates that the virtual node with the identifier “vNode-01” is a dot-shaped virtual node as illustrated on a screen GI in FIG. 14, and its position (x coordinate, y coordinate) is (50, 50).

The example illustrated in FIG. 13 secondly indicates that the virtual node with the identifier “vNode-02” is a linear virtual node as illustrated on the screen G1 in FIG. 14, and its position (x coordinate, y coordinate) is (0-100, 100) with the x coordinate ranging from “0” to “100”.

The example illustrated in FIG. 13 thirdly indicates that the virtual node with the identifier “'Node-03” is a linear virtual node as illustrated on the screen G1 in FIG. 14, and its position (x coordinate, y coordinate) is (0-100, 0) with the x coordinate ranging from “0” to “100”.

Here, it is assumed that a position of a virtual node does not change by attraction or repulsion between nodes.

It is also assumed that a linear virtual node behaves, to each node, similarly to a case where the virtual node is at a point that is closest to the node among points on the line.

The configuration information input unit 11 stores the network configuration information in each information storage unit according to an operation by a user or the like of the system.

For example, the configuration information input unit 11 updates the information stored in the configuration information storage unit 13b, the arrangement information storage unit 13d, and the virtual node information storage unit 13a.

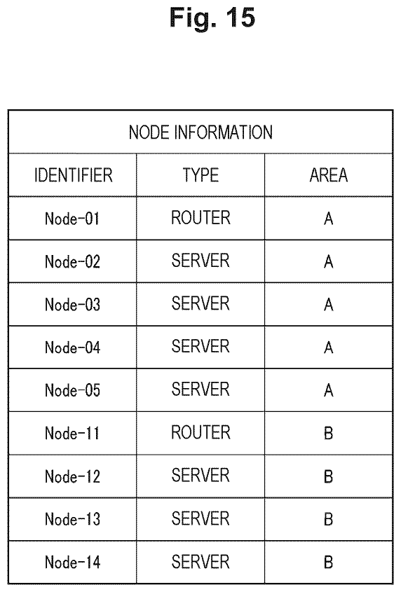

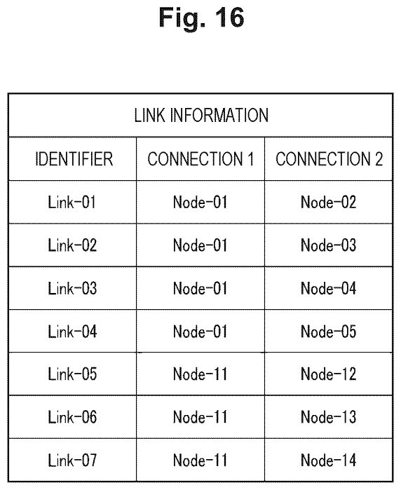

FIG. 15 is a diagram illustrating, in tabular form, an example of the node information that is updated. FIG. 16 is a diagram illustrating, in tabular form, an example of the link information that is updated.

In the examples illustrated in FIGS. 15 and 16, the node information and the link information that are updated indicate a configuration in which four servers are connected to one router in an area A and a configuration in which three servers are connected to one router in an area B.

In the examples illustrated in FIGS. 15 and 16, router and server, which are the types of devices, are set as types of nodes. Alternatively, any type may be set regardless of the type of devices as long as the type is common to the nodes in a plurality of areas.

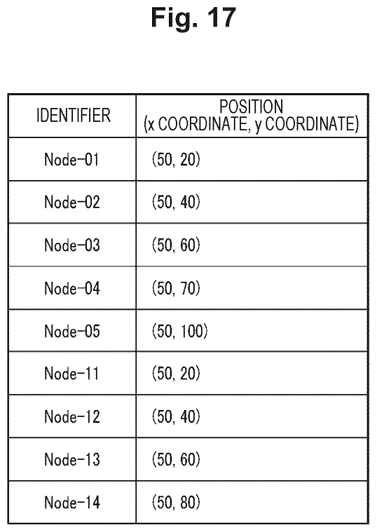

FIG. 17 is a diagram illustrating, in tabular form, an example of the arrangement information that is updated.

FIG. 17 indicates the position information of each node corresponding to the node information illustrated in FIG. 15 and the link information illustrated in FIG. 16.

In the arrangement information that is updated, the position of each node that is a newly registered position is initialized to any value, for example, a random value.

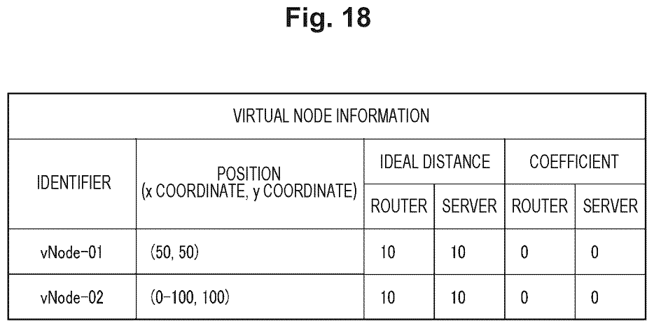

FIG. 18 is a diagram illustrating, in tabular form, an example of the virtual node information to which types of nodes are added.

FIG. 18 illustrates an example in which router or server that are types of nodes, and a value of the ideal distance and a value of the coefficient related to the nodes of each type are added to the column of ideal distance and the column of coefficient in the virtual node information illustrated in FIG. 14.

Here, the values of the columns that have been newly added are initialized to any values.

In the example illustrated in FIG. 18, the coefficient is set to 0, that is, it is assumed that no attraction and no repulsion are applied to nodes.

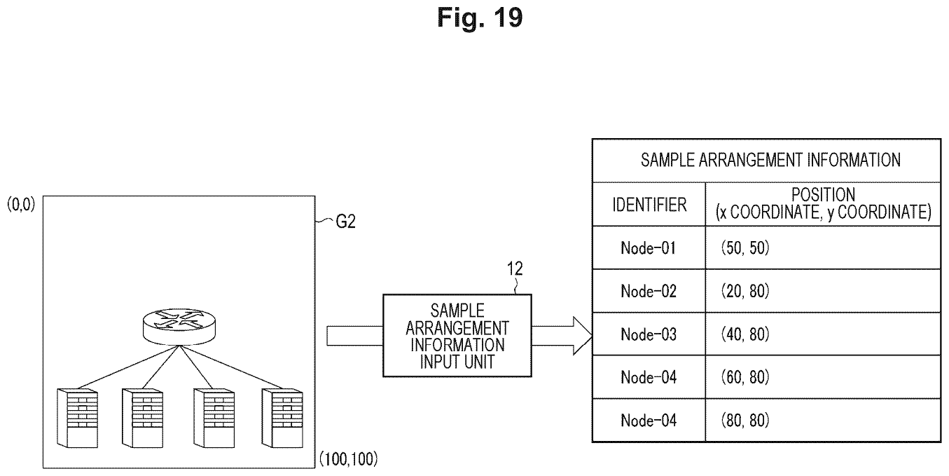

Next, an example of input of the sample arrangement information will be described. FIG. 19 is a diagram illustrating an example of input of the sample arrangement in

The sample arrangement information input unit 12 inputs sample arrangement information indicating a manual arrangement result related to nodes in any area among the areas indicated by the node information of the configuration information according to an input operation by a user or the like of the system, and updates the sample arrangement information stored in the sample arrangement information storage unit 13c according to the input.

In FIG. 19, a screen G2 is illustrated as an example in which five nodes are manually arranged at any positions in the area A.

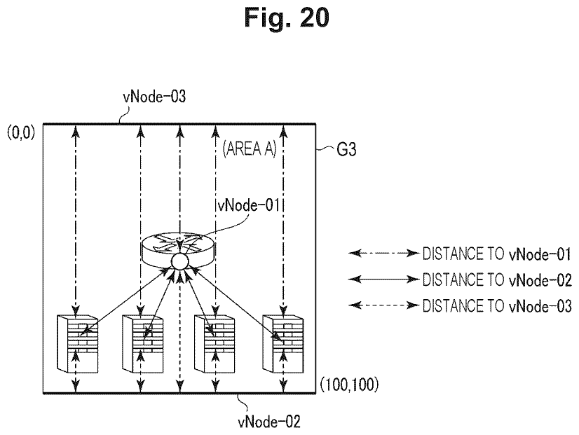

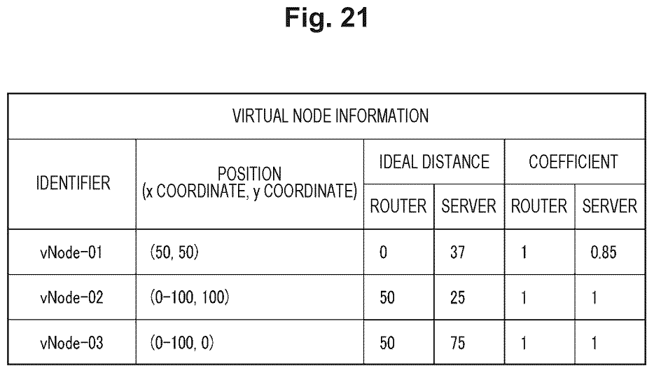

Next, an example of parameter calculation will be described. FIG. 20 is a diagram illustrating an example of parameter calculation of the virtual node information. FIG. 21 is a diagram illustrating, in tabular form, an example of the virtual node information reflecting the parameters that are calculated.

The parameter calculation unit 15 calculates the ideal distance and the coefficent, which are parameters for calculating the attraction and the repulsion applied by each virtual node to the nodes of each type that are arranged at the above-described desired positions in the sample arrangement information, using the information stored in the virtual node information storage unit 13a, the sample arrangement information storage unit 13c, and the configuration information storage unit 13b.

Specifically, the parameter calculation unit 15 acquires a distance between each virtual node and each node of each type arranged at the above-described desired position based on the information stored in each information storage unit to calculate an ideal distance and a coefficient related to the virtual node information for each type of nodes.

A screen G3 illustrated in FIG. 20 indicates (1) a distance between the virtual node “vNode-01” and each node of each type, (2) a distance between the virtual node “vNode-02” and each node of each type, and (3) a distance between the virtual node “vNode-03” and each node of each type.

Furthermore, FIG. 21 indicates an example in which (1) the ideal distance calculated according to the above equation (3) based on each distance illustrated in FIGS. 20 and (2) the coefficient calculated according to the above equation (4) or (5) based on each distance illustrated in FIG. 20 are reflected in the virtual node information.

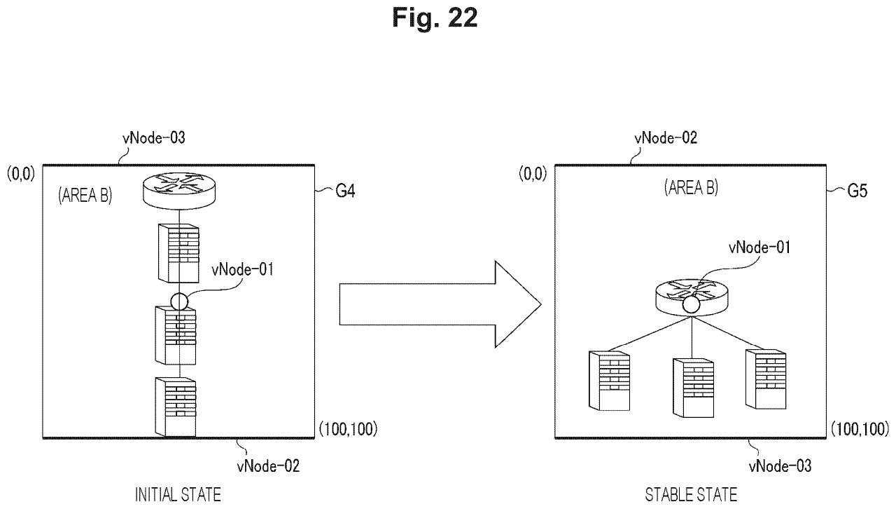

Next, an example of determining arrangement information will be described. FIG. 22 is a diagram illustrating an example of determining arrangement information.

The arrangement information determination unit 14 automatically determines the position of each node of each type in each area using the dynamic model. The attraction or the repulsion applied by the virtual node to each node of each type are determined with reference to the virtual node information stored in the virtual node information storage unit 13a.

In the example illustrated in FIG. 22, from the initial state (screen G4) of the arrangement of each node of each type in the area B, the attraction or the repulsion acting between nodes of each type, and the attraction or the repulsion applied by the virtual node to the nodes of each type are added based on the simulation using the dynamic model, and the stable state (screen G5) of the arrangement of each node of each type in the area B is searched for.

With such a search, the virtual node applies, to each node of each type, forces for making the distances between the nodes of each type closer to the ideal distance, so that an effect is expected that each node of each type in the area B is arranged, as illustrated in FIG. 22, similar to the arrangement of each node in the area A, which is a sample as illustrated in FIG. 19.

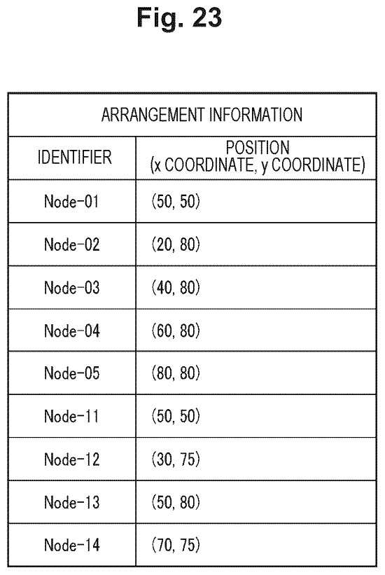

Next, an example of determination and output of arrangement information will be described. FIG. 23 is a diagram illustrating, in tabular form, a calculation result of the arrangement information.

The arrangement information determination unit 14 reflects the calculation result of the arrangement information in the arrangement information stored in the arrangement information storage unit 13d.

The arrangement information output unit 16 displays, on the screen, a network configuration diagram of each area according to the arrangement information. This enables a user or the like of the system to confirm the network configuration diagram of each area on the screen.

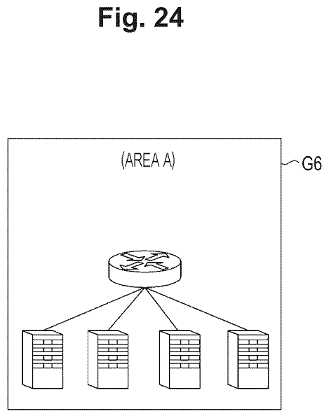

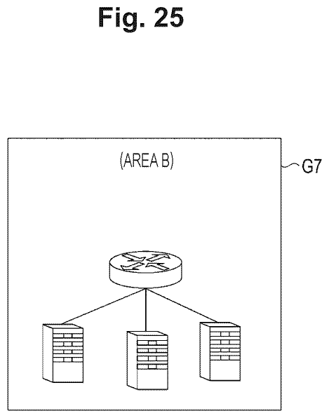

FIGS. 24 and 25 are diagrams illustrating an example of a displaying result of the arrangement information on a screen.

In the present embodiment, any area to be displayed in the network configuration diagram can be selected. According to an operation by a user or the like of the system, the arrangement information output unit 16 displays, based on the arrangement information related to the area that is selected, a network configuration diagram related to the area on the screen.

A screen G6 illustrated in FIG. 24 is a display example of a network configuration diagram related to the area A when the area A is selected. This network configuration diagram is a configuration diagram displayed according' to the arrangement information related to the nodes “Node-01” to “Node-05” in the arrangement information illustrated in FIG. 23.

A screen G7 illustrated in FIG. 25 is a display example of a network configuration diagram related to the area B when the area B is selected. This network configuration diagram is a configuration diagram displayed according' to the arrangement information related to the nodes “Node-11” to “Node-14” in the arrangement information illustrated in FIG. 23.

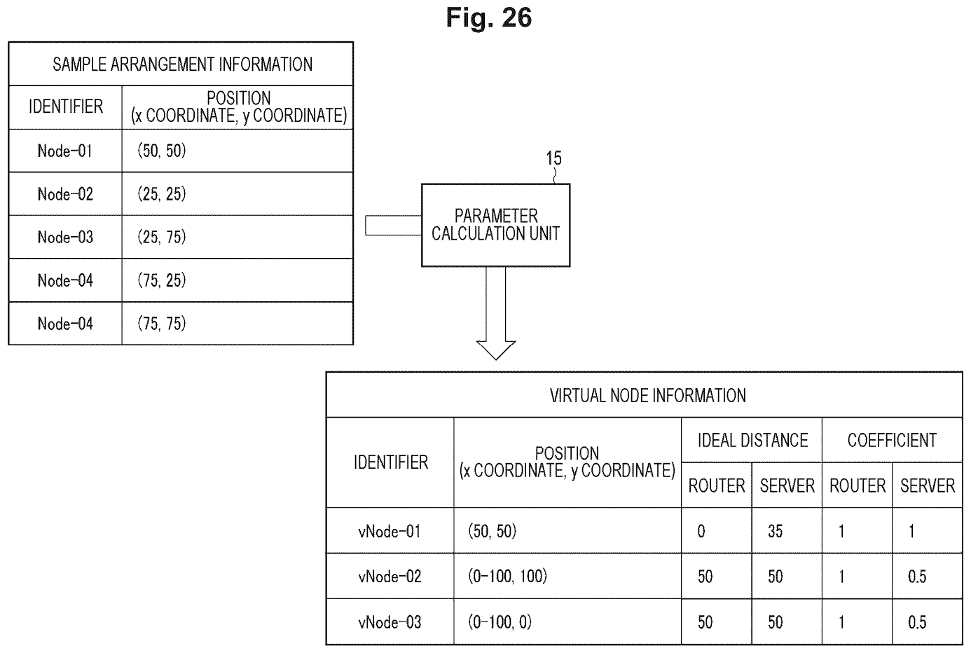

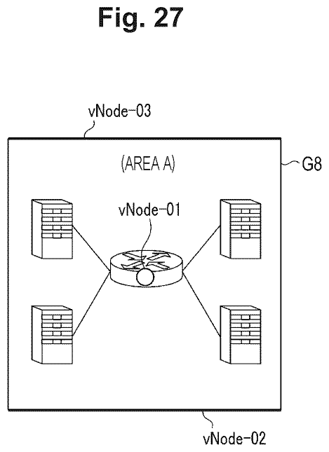

Next, a modification of input of the sample arrangement information will be described. FIG. 26 is a diagram illustrating another example of the sample arrangement information and a result of the parameter calculation. FIG. 27 is a diagram illustrating an example of a displaying result of the arrangement information on a screen.

In a case where sample arrangement information different from the example illustrated in FIG. 19 is input as illustrated in FIG. 26 in the input of the sample arrangement information described above, the result of the parameter calculation is as illustrated in FIG. 26 different from the result illustrated in FIG. 21. Furthermore, the final result of displaying of the arrangement information is as in a screen G8 illustrated in FIG. 27 different from the result illustrated in FIG. 24 and the like.

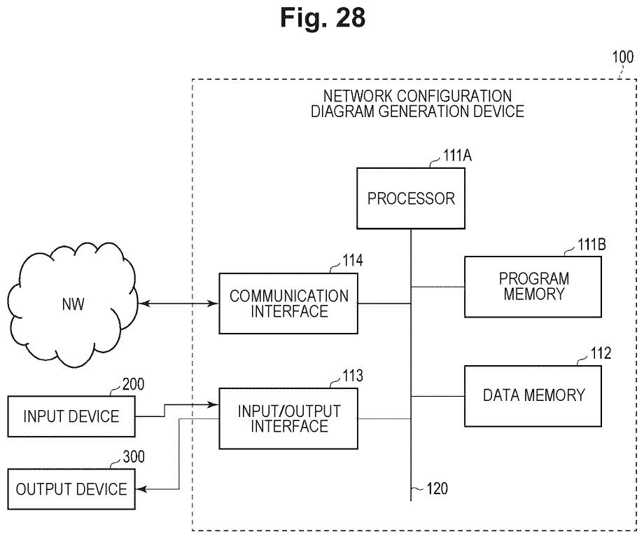

FIG. 28 is a block diagram illustrating an example of a hardware configuration of the network configuration diagram generation device according to an embodiment of the present invention.

In the example illustrated in FIG. 28, the network configuration diagram generation device 100 includes, for example, a server computer or a personal computer, and includes a hardware processor 111A such as a central processing unit (CPU). Then, a program memory 111B, a data memory 112, an input/output interface 113, and a communication interface 114 are connected to the hardware processor 111A via a bus 120.

The communication interface 114 includes, for example, one or more wireless communication interface units, and enables transmission and reception of information to/from a communication network NW. As the wireless interface, for example, an interface employing a low-power wireless data communication standard such as a wireless local area network (LAN) is used.

An input device 200 and an output device 300 that are attached to the network configuration diagram generation device 100 and that are used by a user or the like are connected to the input/output interface 113.

The input/output interface 113 performs processing of fetching operation data input by a user or the like through the input device 200 such as a keyboard, a touch panel, a touchpad, or a mouse, and outputting output data to the output device 300 including a display device using liquid crystal, organic electro-luminescence (EL), or the like to make the output data displayed. Note that, as the input device 200 and the output device 300, a device built in the network configuration diagram generation device 100 may be used, or an input device and an output device of another information terminal that can communicate with the network configuration diagram generation device 100 via the network NW may be used.

The program memory 111B is used as a non-transitory tangible storage medium, for example, in a combination of non--volatile memory enabling writing and reading at any time, such as a hard disk drive (HDD) or a solid state drive (SSD), and non-volatile memory such as read only memory (ROM), and stores programs necessary for executing various control processing according to an embodiment.

The data memory 112 is used as a tangible storage medium, for example, in a combination of the non-volatile memory described above and volatile memory such as random access memory (RAM), and is used to store various types of data acquired and created. in the process of performing various types of processing.

The network configuration diagram generation device 100 according to an embodiment of the present invention can be configured as a data processing device including the configuration information input unit 11, the sample arrangement information input unit 12, the arrangement information determination unit 14, the parameter calculation unit 15, and the arrangement information output unit 16 illustrated in FIG. 1 as a processing function unit by software.

The storage unit 13 and each information storage unit in the storage unit 13 can be configured by using the data memory 112 illustrated in FIG. 28. However, these configured storage areas are not essential configurations in the network configuration diagram generation device 100, and may be areas provided in, for example, an external storage medium such as a universal serial bus (USB) memory or a storage device such as a database server arranged in a cloud.

All of the processing function units in each of the configuration information input unit 11, the sample arrangement information input unit 12, the arrangement information determination unit 14, the parameter calculation unit 15, and the arrangement information output unit 16 described above can be implemented by causing the hardware processor 111A described above to read and execute the program stored in the program memory 111B. Note that some or all of these processing function units may be implemented in other various forms including an integrated circuit such as an application specific integrated circuit. (ASIC) or a field-programmable gate array (FPGA).

As described above, a network configuration diagram generation device according to an embodiment of the present invention receives input of information related to a virtual node that Generates attraction or repulsion on a plurality, of types of nodes displayable in an area of a screen according to the types of the nodes, receives, for each of a plurality of areas on a screen, input of information related to the plurality of types of nodes and links connecting the plurality of types of nodes displayable in the areas, receives, for at least one of the plurality of areas, input of information related to setting of any display positions of the plurality of types of nodes, calculate, for each of the types of the nodes, a parameter for calculating attract on or repulsion applied by the virtual node to the nodes at the display positions of the nodes based on the information that is input, calculates attraction or repulsion applied by the virtual node to the nodes at the display positions of the nodes based on the parameter that is calculated, and determines display positions of the nodes for each of the areas based on the attraction or the repulsion that is calculated. Therefore, nodes in a plurality of areas can be appropriately arranged.

In the above-described embodiment, the application example of the display of the network configuration has been described, but the present invention is not limited thereto, and for example, the present invention can also be applied to arrangement of a plot of a general graph on a screen.

In addition, the method described in each embodiment can be stored in a recording medium such as a magnetic disk (Floppy (registered trademark) disk, hard disk, and the like), an optical disc (CD-ROM, DVD, MO, and the like), or a semiconductor memory (ROM, RAM, flash memory, and the like) as a program (software means) that can be executed by a computer, and can be distributed by being transmitted through a communication medium. Note that the programs stored on the medium side also include a setting program for configuring, in the computer, a software means (including not only an execution program but also tables and data structures) to be executed by the computer. The computer that implements the present device executes the above-described processing by reading the programs recorded in the recording medium, constructing the software means by the setting program as needed, and controlling the operation by the software means. Note that the recording medium described in the present specification is not

limited to a recording medium for distribution, but includes a storage medium such as a magnetic disk or a semiconductor memory provided in the computer or in a device connected via a network.

Note that the present invention is not limited to the foregoing embodiments and various modifications can be made in the implementation stage without departing from the Gist of the invention. In addition, each embodiment may be implemented in appropriate combination, and in that case, combined effects can be obtained. Furthermore, the embodiments described above include various inventions, and various inventions can be extracted by a combination selected from a plurality of disclosed components. For example, even if some components are deleted from all the components described in the embodiment, in a case where the problem can be solved and the effects can be obtained, a configuration from which the components are deleted can be extracted as an invention.

### Reference Signs List

11 Configuration information input unit
12 Sample arrangement information. input. unit
13 Storage unit
13a Virtual node information storage unit
13b Configuration information storage unit
13c Sample arrangement information storage unit
13d Arrangement information storage unit
14 Arrangement information determination unit
15 Parameter calculation unit
16 Arrangement information output unit

1. A position control device,. comprising:
first input circuitry configured to receive input of information related to a virtual node that generates attraction or repulsion on a plurality of types of nodes displayable in an area of a screen according to the types of the nodes, and to receive, for each of a plurality of areas on a screen, input of information related to a plurality of types of nodes and a link connecting the plurality of types of nodes displayable in the areas;
second input circuitry configured to receive, for at least one of the plurality of areas, input of information related to setting of any display positions of the nodes indicated by the information input via the first input circuitry;
parameter calculation circuitry configured to calculate, for each of the types of the nodes, a parameter for calculating attraction or repulsion applied by the virtual node indicated by the information input via the first input circuitry to the nodes at the display positions of the nodes indicated by the information input via the second input circuitry, based on the information input via the first and second input circuitry s; and
determination circuitry configured to calculate attraction or repulsion applied by the virtual node indicated by the information input via the first input circuitry to the nodes at the display positions indicated by the information input via the second input circuitry based on the parameter calculated by the parameter calculation circuitry, and to determine display positions of the nodes indicated by the information input via the second input circuitry for each of the areas based on the attraction or the repulsion that is calculated.

2. The position control device according to claim 1, wherein:
the parameter calculation circuitry calculates, as the parameter, an ideal distance between the virtual node indicated by the information input via the first input circuitry and the nodes at the display positions of the nodes indicated by the information input via the second input circuitry, and a function of a variation in a distance between the virtual node and the nodes at the display positions of the nodes indicated by the information input via the second input circuitry, based on the information input via the first and second input circuitry s.

3. The position control device according to claim 1 further comprising:
output circuitry configured to output a screen indicating positions of the nodes in the areas that are predetermined according to the display positions determined by the determination circuitry.

4. A position control method, comprising:
receiving input of information related to a virtual node that generates attraction or repulsion on a plurality of types of nodes displayable in an area of a screen according to the types of the nodes, and receiving, for each of a plurality of areas of a screen, input of information related to a plurality of types of nodes displayable in the area and a link connecting the plurality of types of nodes;
receiving, for at least one of the plurality of areas, input of information related to setting of any display positions of the plurality of types of nodes indicated by the information that is input;
calculating, for each of the types of the nodes, a parameter for calculating the attraction or the repulsion applied by the virtual node indicated by the information that is input to the nodes at the display positions of the nodes indicated by the information that is input, based on the information that is input;
calculating attraction or repulsion applied by the virtual node indicated by the information that is input to the nodes at the display positions of the nodes indicated by the information that is input, based on the parameter that is calculated, and determining display positions of the nodes indicated by the information that is input for each of the areas, based on the attraction or the repulsion that is calculated.

5. The position control method according to claim 4, wherein the calculating the parameter includes:
calculating, as the parameter, an ideal distance between the virtual node indicated by the information that is input and the nodes at the display positions of the nodes indicated by the information that is input, and a function of variations in distances between the virtual node and the nodes at the display positions of the nodes indicated by the information that is input, based on the information of the nodes and the link that are input and the information related to the virtual node that is input.

6. The position control method according to claim 4 s further comprising:
outputting a screen indicating positions of the nodes in the areas that are predetermined according to the display positions that are determined.

7. A non-transitory computer readable storage medium storing a position control program for causing a processor to function as each of the circuitries the position control device according to claim 1.

8. A non-transitory computer readable storage medium storing a position control program for causing a processor to perform the method of claim 4.
